(19) United States
(12) Patent Application Publication
(10) Pub. No.: US 2014/0348515 A1
(43) Pub. Date: Nov. 27, 2014

(54) OPTICAL RECEIVER AND METHOD FOR CONTROLLING OPTICAL RECEIVER

(71) Applicant: NEC CORPORATION, Tokyo (JP)

(72) Inventor: Takashi Tsubouchi, Tokyo (JP)

(73) Assignee: NEC Corporation, Tokyo (JP)

(21) Appl. No.: 14/358,266

(22) PCT Filed: Dec. 11, 2012
(86) PCT No.: PCT/JP2012/007884

§ 371 Date: May 15, 2014

(30) Foreign Application Priority Data
Dec. 15, 2011 (JP) 2011-274790

(51) Int. Cl. H04B 10/61; H04L 27/227; H04B 10/2575

(52) U.S. Cl. CPC H04B 10/616; H04B 10/2575; H04L 27/227
USPC 398/202

(57) ABSTRACT

In order to suppress occurrence of a code error which occurs when an optical receiver detects a signal over a wide range of input intensity of the signal light by using a simple configuration, an optical receiver includes local light oscillation unit for generating a local oscillation light with a constant intensity, light mixing unit for mixing the local oscillation light and a first signal light and outputting the mixed light as a second signal light, light receiving unit for converting the second signal light into an electrical signal and outputting the electrical signal as a first electrical signal, amplifying unit for amplifying the first electrical signal with a predeteiniined gain and outputting the amplified signal as a second electrical signal, and a signal processing circuit for processing the second electrical signal, wherein the gain is set so that the amplitude of the second electrical signal may be within an allowable input amplitude range of the signal processing circuit.

### TECHNICAL FIELD

The present invention relates to an optical receiver and a method for controlling an optical receiver and in particular, relates to an optical receiver using the digital coherent reception method and a method for controlling the same.

### BACKGROUND ART

With the increase of the transmission rate of the optical communication system, the optical transmission method using DP-QPSK which efficiently enables large-capacity and high-speed communication is put into practical use. The dual-polarization quadrature phase shift keying is abbreviated as DP-QPSK.

The digital coherent reception method is used for the demodulation of the signal light modulated by the DP-QPSK. In the digital coherent reception method, the received signal light (reception light) is mixed with a LO light (local oscillator light) having an optical frequency approximately equal to that of the reception light by an optical mixer called a 90-degree hybrid circuit. The output light of the 90-degree hybrid circuit is received by a PD (photo diode). The PD outputs a beat signal of the reception light and the LO light to a TIA (trans-impedance amplifier) as a photocurrent. The TIA converts the photocurrent outputted by the PD into a voltage signal and outputs the voltage signal to an ADC (analog-digital converter). The beat signal converted into the digital signal by the ADC is outputted to a signal processing circuit. The signal processing circuit demodulates data to be transmitted by performing a calculation process of the digital signal outputted from the ADC.

A conversion efficiency η is one of the parameters of an optical receiver. The conversion efficiency η is a ratio of the amplitude of the signal inputted to the ADC to the intensity of the signal light inputted to the PD. The amplitude (voltage) V of the signal inputted to the ADC can be expressed by equation (1) by using the conversion efficiency η.

V=η×(P_{sig}×P_{LO})^{1/2} (1)

Where, V is an amplitude (V) of the signal inputted to the ADC, η is a conversion efficiency (V/W) at which the optical signal is converted into the signal inputted to the ADC, P_{sig} is an intensity (W) of the signal light inputted to a light receiving element, and P_{LO} is an intensity (W) of the LO light inputted to a light receiving element.

Generally, the amplitude of the signal inputted to the ADC is limited to the amplitude of the signal which can be processed in the ADC. At the same time, the optical receiver has to normally reproduce the signal light with an intensity in a predetermined range specified in the specification of an optical transmission system. For this reason, the optical receiver needs to be designed so that the amplitude of the signal inputted to the ADC is kept in an allowable range even if the intensity of the light inputted to a reception device varies over the entire specified intensity range.

As shown by equation (1), the amplitude of the signal inputted to the ADC is proportional to a square root of a product of the intensity of the signal light and the intensity of the LO light. Namely, even when the intensity of the signal light is constant, the amplitude of the signal inputted to the ADC can be controlled by changing the intensity of the LO light. Accordingly, even when the range of the input intensity of the signal light is wide, the amplitude of the signal inputted to the ADC can be adjusted so that the amplitude is within the allowable range of the ADC by decreasing or increasing the intensity of the LO light.

In relation to the invention of the present application, a configuration of the optical receiver in which the LO light and the reception light are mixed and converted into an analog electrical signal, and the analog electrical signal is converted into a digital signal is described in patent document 1 and patent document 2.

### CITATION LIST

### Patent Literature

[Patent literature 1] Japanese Patent Application Laid-Open No. 2009-296623
[Patent literature 2] Japanese Patent Application Laid-Open No. 2010-245772

### DISCLOSURE OF THE INVENTION

### Problems to be Solved by the Invention

However, in the digital coherent reception method, when the power of the LO light is changed, the following problem occurs. In an optical module using a semiconductor laser which is generally used as a light source of the LO light, when the power of the LO light source is changed by controlling a drive current, the wavelength and the phase of the LO light outputted by the semiconductor laser vary. However, in the digital coherent reception method, there is a possibility that when the wavelength or the phase of the LO light varies, a code error occurs by the phase slip. For this reason, there is a possibility that when the intensity of the LO light is directly changed during the operation of the optical receiver, the transmission quality degradation due to the code error occurs.

Further, when a variable optical attenuator is provided at the output of the LO light source, the intensity of the LO light can be controlled while keeping the output level of the semiconductor laser constant. However, when the variable optical attenuator is provided outside the LO light source, the number of components of which the optical receiver is composed increases. Therefore, a problem in which the cost and size of the optical receiver cannot be easily reduced occurs.

As mentioned above, the method for controlling the amplitude of the signal inputted to the ADC by decreasing or increasing the intensity of the LO light has the problem that the transmission quality degradation due to the code error occurs or the problem that the cost and size of the optical receiver cannot be easily reduced. The above-mentioned invention described in patent documents 1 and 2 cannot solve these problems.

An object of the present invention is to provide a technology for realizing an optical receiver which can suppress the occurrence of the code error which occurs when the optical receiver detects the signal over a wide range of input intensity of the signal light by using a simple configuration.

### Means for Solving the Problems

An optical receiver of the present invention includes local light oscillation means for generating a local oscillation light with a constant intensity, light mixing means for mixing the local oscillation light and a first signal light and outputting the mixed light as a second signal light, light receiving means for converting the second signal light into an electrical signal and outputting the electrical signal as a first electrical signal, amplifying means for amplifying the first electrical signal with a predetermined gain and outputting the amplified signal as a second electrical signal, and a signal processing circuit for processing the second electrical signal and the gain is set so that the amplitude of the second electrical signal may be within an allowable input amplitude range of the signal processing circuit.

A method for controlling an optical receiver of the present invention p includes: generating a local oscillation light with a constant intensity, mixing the local oscillation light and a first signal light and outputting the mixed light as a second signal light, converting the second signal light into an electrical signal and outputting the electrical signal as a first electrical signal, and amplifying the first electrical signal with a predetermined gain and outputting the amplified signal as a second electrical signal, and setting the gain so that the amplitude of the second electrical signal may be within a predetermined range.

### Effect of the Invention

The present invention has an effect that the occurrence of the code error which occurs when the optical receiver detects the signal can be suppressed over a wide range of input intensity of the signal light by using a simple configuration.

### BRIEF DESCRIPTION OF THE DRAWINGS

FIG. 1 A figure showing a configuration of an optical receiver according to a first exemplary embodiment

FIG. 2 A figure showing a relation between range of intensity of a signal light inputted to PD and range of amplitude of a signal inputted to ADC in a first exemplary embodiment

FIG. 3 A figure showing a configuration of an optical receiver according to a second exemplary embodiment

FIG. 4 A figure showing a configuration of an optical receiver 300 according to a third exemplary embodiment

FIG. 5 A figure showing a relation between range of intensity of a signal light inputted to PD and range of amplitude of a signal outputted by an amplifier in a third exemplary embodiment

FIG. 6 A figure showing a configuration of an optical receiver according to a fourth exemplary embodiment

### DESCRIPTION OF EMBODIMENTS

### First Exemplary Embodiment

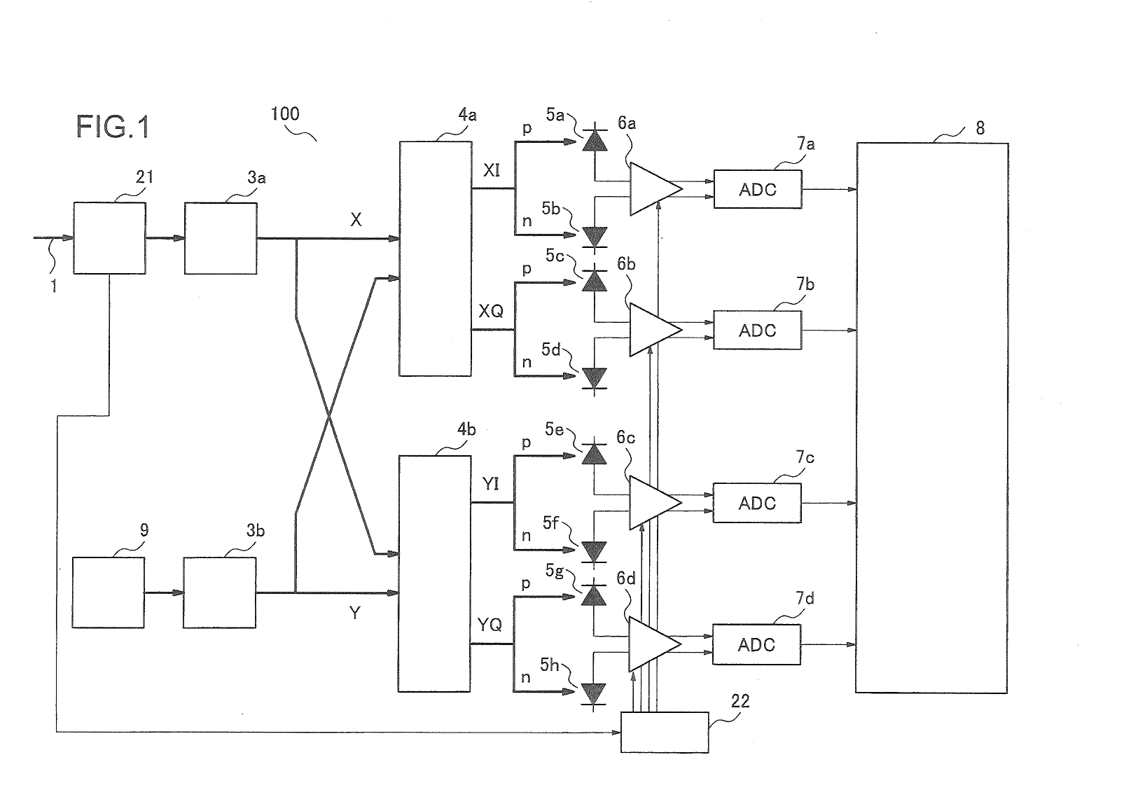

A first exemplary embodiment of the present invention will be described. FIG. 1 shows a configuration of an optical receiver 100 according to the first exemplary embodiment of the present invention. In FIG. 1, the optical receiver 100 includes PBSs (polarization beam splitters) 3a and 3b, 90-degree hybrid circuits 4a and 4b, a LO light generation unit 9, and PDs (photo diodes) 5a to 5h. The optical receiver 100 further includes amplifiers 6a to 6d, ADCs 7a to 7d, a digital signal processing unit 8, a monitor unit 21, and a control unit 22.

The monitor unit 21 outputs an inputted reception signal light 1 to the PBS 3a and outputs an electrical signal proportional to the intensity of the reception signal light 1. The monitor unit 21 includes, for example, an optical splitter and a light receiving element which outputs an electric current proportional to the intensity of the light split by the optical splitter. The control unit 22 controls a gain of the amplifiers 6a to 6d based on the output of the monitor unit 21.

The PBSs 3a and 3b separate the signal light outputted from the monitor unit 21 into an X-polarized signal light and a Y-polarized signal light that are orthogonal to each other. The 90-degree hybrid circuit 4a reproduces an I (inphase) signal and a Q (quadrature) signal from each of the separated signal lights. The 90-degree hybrid circuit 4a outputs a XI signal and a XQ signal that are an output of the I signal and an output of the Q signal. Similarly, the 90-degree hybrid circuit 4b outputs a YI signal and a YQ signal. The LO light generation unit 9 generates the LO light with a constant intensity. PD 5a to 5h are four pairs of twin PDs each of which includes two PDs. PDs 5a to 5h differentially receive the XI signal, the XQ signal, the YI signal, and the YQ signal that are separated by the 90-degree hybrid circuits 4a and 4b by using two channels: p (positive) and n (negative) and output the received signals as a differential current, respectively.

The amplifiers 6a to 6d output the differential currents outputted from the PDs 5a to 5h to the ADCs 7a to 7d as a voltage signal. A TIA can be used for the amplifiers 6a to 6d. The ADCs 7a to 7d convert the analog signals outputted from the amplifiers 6a to 6d into the digital signals. The digital signal processing unit 8 processes the digital signals outputted from the ADCs 7a to 7d. The monitor unit 21 outputs an electrical signal corresponding to the intensity of the inputted signal light.

(Explanation of Operation of the First Exemplary Embodiment)

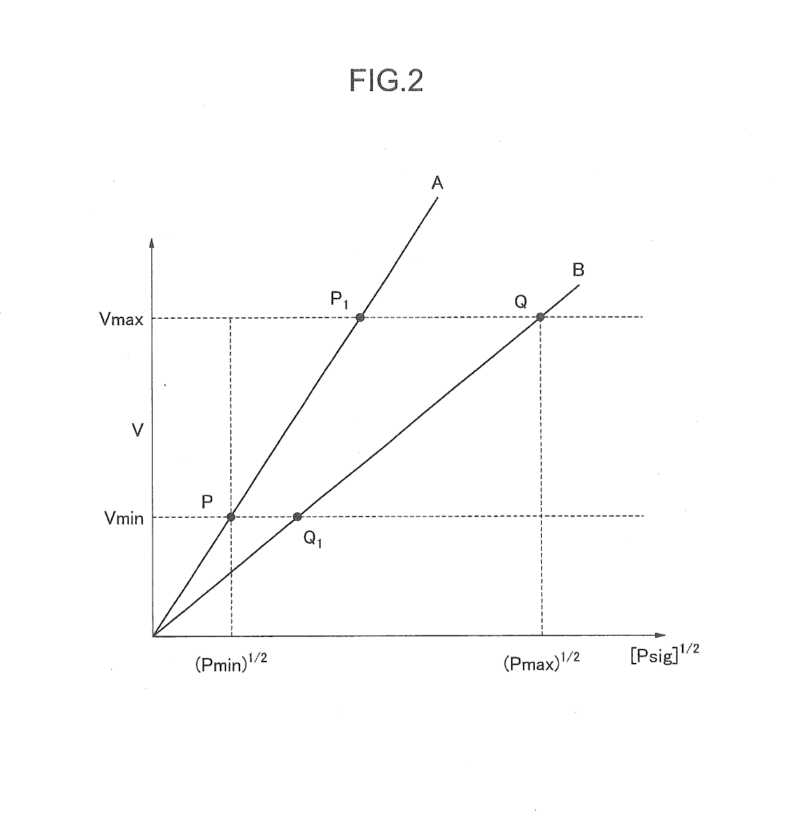

FIG. 2 is a figure showing a relation between range of the intensities P_{sig} of the signal lights inputted to the PDs 5a to 5h and range of the amplitudes V of the signals outputted from the amplifiers 6a to 6d in the optical receiver 100. The horizontal axis of FIG. 2 indicates the intensity P_{sig} of the signal light inputted to the PDs 5a to 5h and the vertical axis indicates the amplitude of the electrical signal outputted by the amplifiers 6a to 6d. The amplitudes of the signals outputted from the amplifiers 6a to 6d are equal to the amplitudes of the signals inputted to the ADCs 7a to 7d. Generally, the amplitudes of the signals inputted to the ADCs 7a to 7d are specified by a voltage.

Vₘᵢₙ and Vₘₐₓ on the vertical axis shown in FIG. 2 represent the minimum allowable input amplitude value and the maximum allowable input amplitude value of the ADCs 7a to 7d. Pₘᵢₙ and Pₘₐₓ on the horizontal axis represent the minimum value and the maximum value of the intensity P_{sig} of the signal lights received by the PDs 5a to 5h. The minimum value and the maximum value of the intensity P_{sig} correspond to the range of amplitude of the signals inputted to the ADCs 7a to 7d. In the signal light receiving range specified in the specification of the optical receiver 100, when the range of intensities of the signal lights received by the PDs 5a to 5h is between Pₘᵢₙ and Pₘₐₓ, the amplitudes of the electrical signals outputted by the amplifiers 6a to 6d are between Vmin and Vmax.

Namely, FIG. 2 shows an overall characteristic of a light-to-electric conversion process performed by the PDs 5a to 5h and a current-to-voltage conversion process performed by the amplifiers 6a to 6d when the intensity P_{sig} of the signal light inputted to the PDs 5a to 5h is converted into the amplitude V inputted to the ADCs 7a to 7d.

Here, the above-mentioned equation (1) can be deformed to the following equation (2).

V=[η×(P_{Lo})^{1/2}]×(P_{sig})^{1/2} (2)

Namely, when the horizontal axis of FIG. 2 represents the value of (P_{sig})^{1/2}, the relation between the square root of the intensity P_{sig} of the signal lights received by the PDs 5a to 5h and the amplitude V of the electrical signals outputted by the amplifiers 6a to 6d is linear as shown in FIG. 2. In FIG. 2, each of (Pₘᵢₙ)^{1/2} and (Pₘₐₓ)^{1/2} represents the value of (P_{sig})^{1/2} when the intensity P_{sig} of the signal lights received by the PDs 5a to 5h is minimum and maximum, respectively. Vₘᵢₙ and Vₘₐₓ respectively represent the value of V when the amplitudes of the signals outputted from the amplifiers 6a to 6d is minimum allowable input amplitude value and the maximum input amplitude value of the ADCs 7a to 7d.

Here, the gradients of the straight lines A and B shown in FIG. 2 are given by η×(P_{LO})^{1/2} in equation (1). The conversion efficiency η can be also expressed by equation of η=η_{PD}×ηₐₘₚ, where η_{PD}(A/W) is the quantum efficiency of the PDs 5a to 5h and ηₐₘₚ(V/A) is the gain of the amplifiers 6a to 6d. It is considered that the quantum efficiencies η_{PD} of the PDs 5a to 5h may be constant for each PD. Further, in this exemplary embodiment, it is assumed that the intensity P_{LO} of the LO light is kept constant. Accordingly, the gradients K_{A} and K_{B} of the straight lines A and B are expressed by the following equations, where η_{A} and η_{B} are the gains of the amplifiers 6a to 6d at the points P and Q, respectively.

K_{A}=[η_{PD}×(P_{LO})^{1/2}]×η_{A} (3)

K_{B}=[η_{PD}×(P_{LO})^{1/2}]η_{B} (4)

When (P_{sig})^{1/2}=(Pₘᵢₙ)^{1/2}, namely, the intensity of the signal light is minimum (Pₘᵢₙ), the point P shown in FIG. 2 shows a point at which the amplitudes of the signals outputted from the amplifiers 6a to 6d satisfy the minimum allowable input amplitude value (Vₘᵢₙ) of the ADCs 7a to 7d. The gradient K_{A} of the straight line A through the point P corresponds to the gain η_{A} of the amplifiers 6a to 6d. However, when the amplifiers 6a to 6d are used as a constant gain amplifier whose gain corresponds to the gradient of the straight line A, when the intensity P_{sig} of the signal light becomes high, the amplitudes V of the signals inputted to the ADCs 7a to 7d exceed Vₘₐₓ (point P₁) even when the intensity P_{sig} is lower than Pₘₐₓ.

On the other hand, when (P_{sig})^{1/2}=(Pₘₐₓ)^{1/2}, namely, the intensity of the signal light is maximum (Pₘₐₓ), the point Q shown in FIG. 2 shows a point at which the amplitudes of the signals outputted from the amplifiers 6a to 6d satisfy the maximum allowable input amplitude value (Vₘₐₓ) of the ADCs 7a to 7d. The gradient K_{B} of the straight line B through the point Q corresponds to the gain K_{B} of the amplifiers 6a, 6b, 6c, and 6d. However, when the amplifiers 6a to 6d are used as a constant gain amplifier whose gain corresponds to the gradient of the straight line B, when the intensity P_{sig} of the signal light is low, the amplitudes V of the signals inputted to the ADCs 7a to 7d are less than Vₘᵢₙ (point Q₁) even when the intensity P_{sig} is higher than Pₘᵢₙ.

For this reason, in FIG. 2, when the gain ηₐₘₚ of the amplifiers 6a to 6d is set to a constant value, there is a possibility that when a variation range of the intensity P_{sig} of the signal lights inputted to the PDs 5a to 5h is approximately equal to a range from Pₘᵢₙ to Pₘₐₓ, the amplitudes of the output signals of the amplifiers 6a to 6d exceed the allowable input amplitude range of the ADCs 7a to 7d.

Accordingly, the optical receiver 100 controls the gain ηₐₘₚ of the amplifiers 6a to 6d so that the amplitudes V of the signals outputted from the amplifiers 6a to 6d may be in the allowable input amplitude range of the ADCs 7a to 7d. Here, when the gain ηₐₘₚ of the amplifiers 6a to 6d is controlled, it is not necessary to change the intensity P_{LO} of the LO light and the value of the intensity P_{LO} is maintained to a constant value.

Specifically, the monitor unit 21 monitors the intensity of the signal light inputted to the optical receiver 100 and outputs the electrical signal with the amplitude proportional to the intensity of the inputted signal light to the control unit 22. The control unit 22 controls the gain ηₐₘₚ of the amplifiers 6a to 6d based on the amplitude of the electrical signal inputted from the monitor unit 21. For example, when the intensity of the signal light inputted to the optical receiver 100 is low, the control unit 22 controls the gain ηₐₘₚ of the amplifiers 6a to 6d so that the gain ηₐₘₚ may be equal to the gain η_{A} corresponding to the gradient K_{A} of the straight line A shown in FIG. 2. Then when the intensity of the signal light increases, the control unit 22 controls the gain ηₐₘₚ so that the gain ηₐₘₚ may be close to the gain η_{B} corresponding to the gradient K_{B} of the straight line B shown in FIG. 2.

Here, the gain ηₐₘₚ may be controlled so that the gain ηₐₘₚ may smoothly follow the change in intensity of the signal light inputted to the optical receiver 100. For example, when P_{sig}=Pₘᵢₙ, the control unit 22 sets the gain ηₐₘₚ to η_{A} and when P_{sig}=Pₘₐₓ) the control unit 22 sets the gain ηₐₘₚ to η_{B}. When the intensity P_{sig} increases from Pₘᵢₙ to Pₘₐₓ, the control unit 22 may decrease the gains of the amplifiers 6a to 6d from η_{A} to η_{B} according to the value of P_{sig}. Alternatively, the range of intensity of the signal light inputted to the optical receiver 100 may be divided into a plurality of ranges, the gain of the amplifier ηₐₘₚ is determined for each of the plurality ranges, and is set to a predetermined value according to the intensity of the inputted signal light may be used.

Because the control unit 22 controls the gain ηₐₘₚ as mentioned above, the amplitude V of the signals outputted from the amplifiers 6a to 6d can be set to the allowable input amplitude range of the ADCs 7a to 7d.

Further, the gain ηₐₘₚ of the amplifiers 6a to 6d may be controlled so that when the signal light having an intensity range from Pₘᵢₙ to Pₘₐₓ is inputted, the signal with the amplitude range from Vₘᵢₙ to Vₘₐₓ is outputted. Namely, the procedure of adjusting the gain ηₐₘₚ by the control unit 22 is not limited to the above-mentioned method.

Thus, in the optical receiver 100, the control unit 22 controls the gain of the amplifiers 6a to 6d so that the amplitude of the signals outputted from the amplifiers 6a to 6d may not deviate from the allowable input amplitude range of the ADCs 7a to 7d. Namely, in the optical receiver 100, while keeping the intensity of the LO light constant, the gain of the amplifiers 6a to 6d is controlled and whereby, the amplitude of the signals inputted to the ADCs 7a to 7d is maintained within the allowable range.

Further, the PDs 5a to 5h, the amplifiers 6a to 6d, and the ADCs 7a to 7d are respectively disposed in the paths of the signals (XI, XQ, YI, and YQ). Accordingly, the gains ƒₐₘₚ of the amplifiers 6a to 6d may be set to the different values according to the characteristic of the component of which each signal path is composed.

Thus, in the optical receiver 100 according to the first exemplary embodiment, the control unit 22 controls the gains ηₐₘₚ of the amplifiers 6a to 6d so that the amplitudes of the output signals of the amplifiers 6a to 6d may be in the allowable input amplitude range of the ADCs 7a to 7d without changing the intensity P_{LO} of the LO light. As a result, the optical receiver 100 according to the first exemplary embodiment has an effect that even when the input range of intensity of the signal light is wide, the occurrence of the code error which occurs when the optical receiver detects the signal can be suppressed by using a simple configuration.

Next, the setting of the intensity P_{LO} of the LO light will be described. However, the setting procedure explained below is an example. Therefore, the method for setting the intensity P_{LO} of the LO light is not limited to the following method.

In equation (2), because η=η_{PD}×ηₐₘₚ, the amplitude V of the signal in equation (2) inputted to the ADC is expressed by the following equation.

V=[η×l (P_{LO})^{1/2}]×(P_{sig})_{1/2}=[(η_{PD}×ηₐₘₚ)×(P_{LO})^{1/2}]×(P_{sig})^{1/2} (5)

From equation (5), ηₐₘₚ can be obtained by the following equation.

ηₐₘₚ=V/[η_{PD}×(P_{LO})^{1/2}×(P_{sig})^{1/2}] (6)

Here, when the intensity of the LO light is set, the P_{LO} is adjusted so that the value of η_{PD}×(P_{LO})^{1/2} may be equal to a predetermined constant value G Namely, P_{LO}=(G/η_{PD})². As a result, ηₐₘₚ can be expressed by equation (7).

ηₐₘₚ=V/[G×(P_{sig})^{1/2}] (7)

By using equation (7), even when the quantum efficiency η_{PD} and the intensity P_{LO} of the LO light are unknown, the range of the gain ηₐₘₚ by which when changing the P_{sig}, the amplitude V of the ADC input signal does not exceed the allowable input amplitude range can be obtained. Thus, by adjusting the P_{LO} so as to satisfy P_{LO}=(G/η_{PD})², the range in which the gain ηₐₘₚ is controlled can be known even before the intensity P_{LO} of the LO light is set. As a result, the circuit can be most suitably adjusted in the range of the gain in which the amplifiers 6a to 6d are used at the time of the production of the optical receiver. Further, an order of implementation of a process for setting the intensity of the LO light and a process for setting the gain ηₐₘₚ of the amplifiers 6a to 6d can be determined freely at the time of the production of the optical receiver.

Further, one of the quantum efficiencies of the PDs 5a to 5h may be used for the quantum efficiency η_{PD} used when the intensity P_{LO} of the LO light is determined from the value of G as a representative value. Alternatively, the value of the quantum efficiency η_{PD} used when the intensity P_{LO} of the LO light is determined may be calculated based on a part of or all the values of the quantum efficiencies of the PDs 5a to 5h. For example, the average value of the quantum efficiencies of the PDs 5a to 5h may be used as the value of the quantum efficiency η_{PD}.

Incidentally, the intensity P_{sig} of the signal lights inputted to the PDs 5a to 5h can be calculated by adding the loss of the monitor unit 21, the loss of the PBS 3a, and the loss of the 90-degree hybrid circuit 4a or the 90-degree hybrid circuit 4b, to the intensity of the reception signal light 1 inputted to the optical receiver 100. Further, the intensity P_{LO} of the LO light inputted to the PDs 5a to 5h can be calculated by adding the loss of the PBS 3b and the loss of the 90-degree hybrid circuit 4a or the 90-degree hybrid circuit 4b to the intensity of the LO light outputted from the LO light source 9.

In the first exemplary embodiment, it is shown that the gain ηₐₘₚ of the amplifiers 6a to 6d is changed between the gain corresponding to the gradient of the straight line A and the gain corresponding to the gradient of the straight line B. However, the control characteristic of the gain ηₐₘₚ is not limited to the above-mentioned description. The gain ηₐₘₚ of the amplifiers 6a to 6d may be controlled so that when the intensity of the signal lights inputted to the PDs 5a to 5h changes from Pₘᵢₙ to Pₘₐₓ, the amplitude of the signals outputted from the amplifiers 6a to 6d monotonously changes in a range from Vₘᵢₙ to Vₘₐₓ.

### Second Exemplary Embodiment

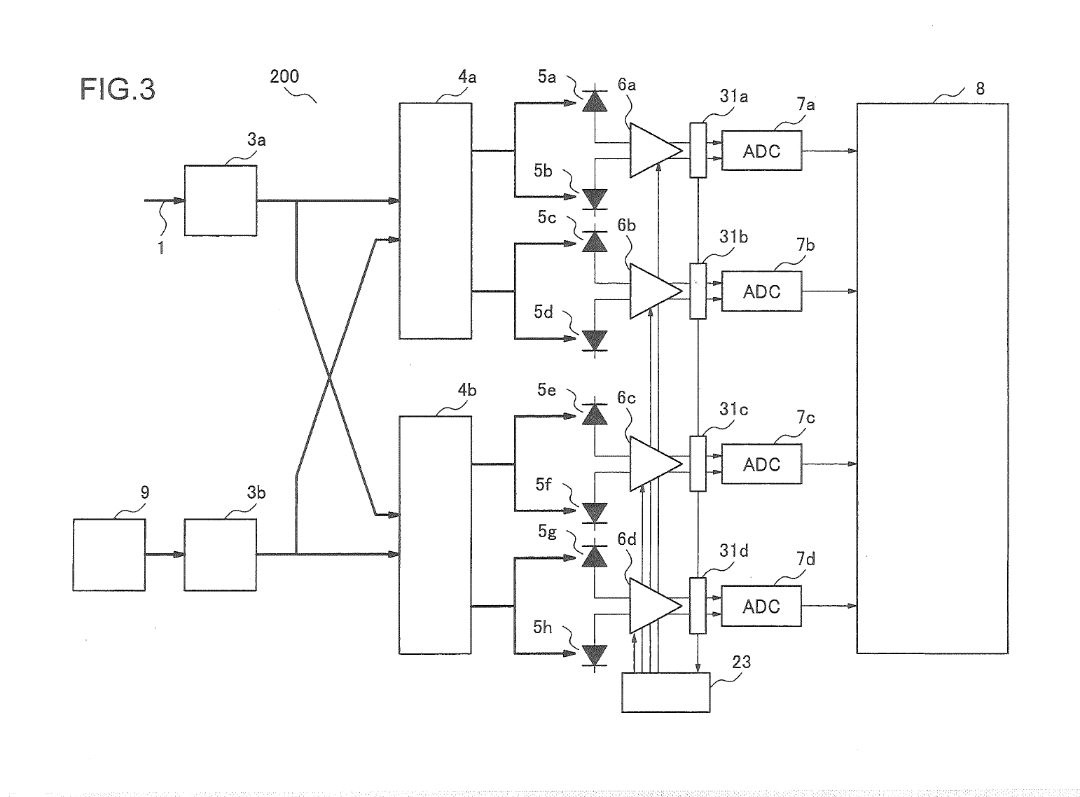

FIG. 3 is a figure showing a configuration of an optical receiver 200 according to a second exemplary embodiment of the present invention. In FIG. 3, the optical receiver 200 includes the PBSs 3a and 3b, the 90-degree hybrid circuits 4a and 4b, the LO light generation unit 9, and the PDs 5a to 5h. The optical receiver 200 further includes the amplifiers 6a to 6d, the ADCs 7a to 7d, the digital signal processing unit 8, monitor units 31a to 31d, and a control unit 23.

The optical receiver 200 shown in FIG. 3 includes the monitor units 31a to 31d instead of the monitor unit 21 included in the optical receiver 100 shown in FIG. 1 and this is a difference between the optical receiver 200 and the optical receiver 100. The method for controlling the gain ηₐₘₚ of the amplifiers 6a to 6d performed by the control unit 23 is different from the method performed by the control unit 22 of the optical receiver 100. The same reference numbers are used for the elements of the optical receiver 200 which have the same function as the elements of the optical receiver 100 shown in FIG. 1 and the description of the element will be omitted.

The monitor units 31a to 31d are disposed between the amplifiers 6a to 6d and the ADCs 7a to 7d, respectively. The monitor units 31a to 31d output the signals corresponding to the amplitudes of the signals outputted from the amplifiers 6a to 6d to the control unit 23, respectively. The control unit 23 controls the gain ηₐₘₚ so that the amplitudes V of the signals outputted from the amplifiers 6a to 6d are in the allowable input amplitude range of the ADCs 7a to 7d based on the outputs of the monitor units 31a to 31d, respectively.

For example, the control unit 23 may control the gain ηₐₘₚ so that the amplitudes V may be set to a constant value in the allowable input amplitude range of the ADCs 7a to 7d. Alternatively, the control unit 23 may control the gain ηₐₘₚ so that the amplitudes V may not exceed the upper and lower limit of the allowable input amplitude range of the ADCs 7a to 7d.

Namely, even in the optical receiver 200 according to the second exemplary embodiment, in a state in which the intensity P_{LO} of the LO light is kept constant, the gains ηₐₘₚ of the amplifiers 6a to 6d are controlled so that the amplitudes of the output signals of the amplifiers 6a to 6d may be in the allowable input amplitude range of the ADCs 7a to 7d. As a result, the optical receiver 200 according to the second exemplary embodiment has an effect that even when the input range of intensity of the signal light is wide, the occurrence of the code error which occurs when the optical receiver detects the signal can be suppressed by using a simple configuration like the first exemplary embodiment.

Incidentally, in the second exemplary embodiment, the monitor units 31a to 31d are disposed between the amplifiers 6a to 6d and the ADCs 7a to 7d, respectively. As a result, the optical receiver 200 according to the second exemplary embodiment has an effect that the gain ηₐₘₚ of the amplifiers 6a to 6d can be more precisely controlled according to the intensity for each path of the signals (XI, XQ, YI, and YQ).

In the first and second exemplary embodiments described above, it has been explained that the monitor unit is disposed in an input section of the optical receiver 100 or at the output of the amplifiers 6a to 6d. However, the monitor unit can be disposed at an arbitrary position where the intensity of the signal light inputted to the optical receiver can be detected. For example, the monitor unit may be disposed between the PBS 3a and the 90-degree hybrid circuit 4a, and between the PBS 3a and the 90-degree hybrid circuit 4b.

### Third Exemplary Embodiment

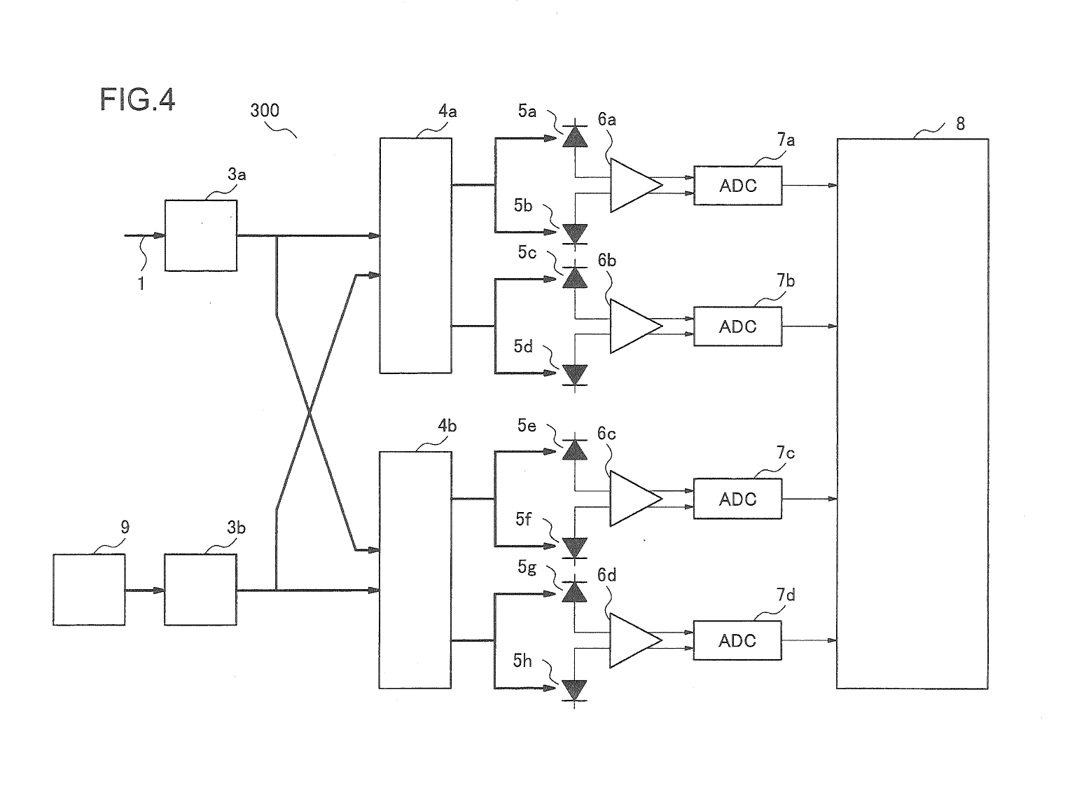

FIG. 4 is a figure showing a configuration of an optical receiver 300 according to a third exemplary embodiment of the present invention. In FIG. 4, the optical receiver 300 includes the PBSs 3a and 3b, the 90-degree hybrid circuits 4a and 4b, the LO light generation unit 9, and the PDs 5a to 5h. The optical receiver 300 further includes the amplifiers 6a to 6d, the ADCs 7a to 7d, and the digital signal processing unit 8.

The configuration of the optical receiver 300 shown in FIG. 4 differs from the configuration of the optical receiver 100 shown in FIG. 1 or the optical receiver 200 shown in FIG. 2 in that the optical receiver 300 does not include the monitor units 21, 31a to 31d and the control units 22 and 23. Because the elements of the optical receiver 300 are the same as the elements of the optical receiver 100 and 200, the same reference numbers are used for the elements of the optical receiver 300 and the description of the elements will be omitted.

Because the optical receiver 300 does not include the monitor unit and the control unit, the gain ηₐₘₚ of the amplifiers 6a to 6d under operation is constant. A case in which in the third exemplary embodiment, even when the gain ηₐₘₚ of the amplifiers 6a to 6d is kept constant, the amplitudes of the output signals of the amplifiers 6a to 6d can be kept within the allowable input amplitude range of the ADCs 7a to 7d will be described.

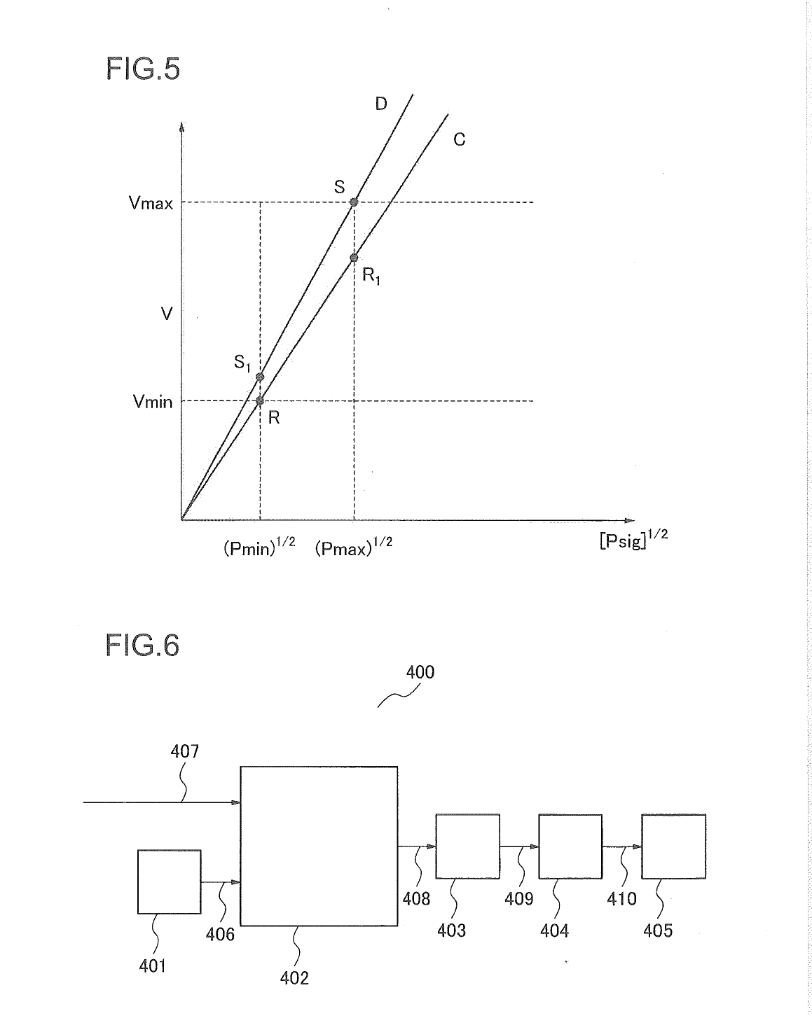

FIG. 5 is a figure showing a relation between a range of the intensities P_{sig} of the signal lights inputted to the PDs 5a to 5h and a range of the amplitudes V of the signals outputted by the amplifiers 6a to 6d in the optical receiver 300. In FIG. 5, like FIG. 2, the horizontal axis indicates the value of the intensity (P_{sig})^{1/2}, where (P_{sig})^{1/2} is a square root of the intensity P_{sig} of the signal lights inputted to the PDs 5a to 5h. The vertical axis indicates V which is the amplitude of the electrical signals outputted by the amplifiers 6a to 6d. Straight lines C and D shown in FIG. 5 indicate a characteristic when converting the intensity of the signal lights inputted to the PDs 5a to 5h into the amplitude of the signals inputted to the ADCs 7a to 7d, like FIG. 2.

When (P_{sig})^{1/2}=(Pₘᵢₙ)^{1/2}, namely, the intensity of the signal light is minimum (Pₘᵢₙ), the point R shown in FIG. 5 shows a point at which the amplitudes of the signals outputted from the amplifiers 6a to 6d satisfy the minimum allowable input amplitude value (Vₘᵢₙ) of the ADCs 7a to 7d. A gradient K_{C} of the straight line C at the point R corresponds to the gain ηₐₘₚ of the amplifiers 6a to 6d at that time. In FIG. 5, even when the amplifiers 6a to 6d are used as a constant gain amplifier whose gain corresponds to the gradient of the straight line C, the amplitude V of the signals inputted to the ADCs 7a to 7d does not exceed Vₘₐₓ even when the intensity P_{sig} of the signal light is equal to Pₘₐₓ (point R1).

On the other hand, when (P_{sig})^{1/2}=(Pₘₐₓ)^{1/2}, namely; the intensity of the signal light is maximum (Pmax), the point S shown in FIG. 5 shows a point at which the amplitudes of the signals outputted from the amplifiers 6a to 6d satisfy the maximum allowable input amplitude value (Vₘₐₓ) of the ADCs 7a to 7d. A gradient K_{D} of the straight line D at the point S corresponds to the gain ηₐₘₚ of the amplifiers 6a to 6d at that time. In FIG. 5, even when the amplifiers 6a to 6d are used as a constant gain amplifier whose gain corresponds to the gradient of the straight line D, the amplitude V of the signals inputted to the ADCs 7a to 7d is not less than Vₘᵢₙ even when the intensity P_{sig} of the signal light is equal to Pₘᵢₙ (point S1).

For this reason, in FIG. 5, even when the gain ηₐₘₚ is set to a constant value between the gains corresponding to the gradients of the straight lines C and D, the amplitude V does not exceed the allowable input amplitude range of the ADCs 7a to 7d when the intensity P_{sig} of the signal light varies in a range from Pₘᵢₙ to Pₘₐₓ. Accordingly, when the relation of the range from Pₘᵢₙ to Pₘₐₓ and the range from Vₘᵢₙ to Vₘₐₓ satisfies the condition shown in FIG. 5 and the above-mentioned relation, in the optical receiver 300, a monitor function can be deleted and the gain ηₐₘₚ of the amplifiers 6a to 6d can be fixed at the time of production.

Even in the optical receiver 300 according to the third exemplary embodiment having such configuration, even when the intensity of the signal light changes from the minimum value to the maximum value of the variation range in a state in which the intensity P_{LO} of the LO light is kept constant, the amplitudes of the output signals of the amplifiers 6a to 6d are kept within the allowable input amplitude range of the ADCs 7a to 7d. As a result, the optical receiver 300 according to the third exemplary embodiment has an effect that even when the input range of intensity of the signal light is wide, the occurrence of the code error which occurs when the optical receiver detects the signal can be suppressed by using a simple configuration like the optical receivers according to the first and second exemplary embodiments. Moreover, because the optical receiver 300 according to the third exemplary embodiment does not include the monitor unit and the control unit, the optical receiver 300 has an effect that the configuration of the optical receiver can be simplified and the cost and size of the optical receiver can be reduced.

### Fourth Exemplary Embodiment

FIG. 6 is a figure showing a configuration of an optical receiver of a fourth exemplary embodiment of the present invention. An optical receiver 400 includes a local light oscillation unit 401, a light mixing unit 402, a light receiving unit 403, an amplifying unit 404, and a signal processing circuit 405.

The local light oscillation unit 401 generates a local oscillation light 406 with a constant intensity. The light mixing unit 402 mixes the local oscillation light 406 and a first signal light 407 and outputs the mixed light as a second signal light 408. The light receiving unit 403 converts the second signal light 408 into an electrical signal and outputs the electrical signal as a first electrical signal 409. The amplifying unit 404 amplifies the first electrical signal 409 with a predetermined gain and outputs the amplified signal as a second electrical signal 410. The signal processing circuit processes the second electrical signal 410. The gain of the amplifying unit 404 is set so that the amplitude of the second electrical signal 410 is within the allowable input amplitude range of the signal processing circuit 405.

In the optical receiver 400, the intensity of the local oscillation light 406 is kept constant. In the optical receiver 400, the gain of the amplifying unit 404 is set so that the amplitude of the first electrical signal 410 inputted to the signal processing circuit 405 may be within the allowable input amplitude range of the signal processing circuit 405 even when the intensity of the first signal light 407 changes.

Namely, a frequency and a phase of the local oscillation light 406 do not vary because the optical receiver 400 does not change the intensity of the local oscillation light 406 even when the intensity of the first signal light 407 changes. As a result, because a phase slip between the first signal light 407 and the local oscillation light 406 does not occur in the light mixing unit 402 even when the intensity of the first signal light 407 changes, the optical receiver 400 can suppress the occurrence of the signal error which occurs at the time of the signal detection.

The invention of the present application has been described above with reference to the exemplary embodiment. However, the invention of the present application is not limited to the above mentioned exemplary embodiment. Various changes in the configuration or details of the invention of the present application that can be understood by those skilled in the art can be made without departing from the scope of the invention of the present application.

This application claims priority based on Japanese Patent Application No. 2011-274790, filed on Dec. 15, 2011, the disclosure of which is hereby incorporated by reference in its entirety.

### REFERENCE SIGNS

100, 200, 300, and 400 optical receiver
1 reception signal light
3a and 3b PBS
4a and 4b 90-degree hybrid circuit
5a to 5h PD
6a to 6d amplifier
7a to 7d ADC
8 digital signal processing unit
9 LO light generation unit
21, 31a to 31d monitor unit
22 and 23 control unit
401 local light oscillation unit
402 light mixing unit
403 light receiving unit
404 amplifying unit
405 signal processing circuit
406 local oscillation light
407 first signal light
408 second signal light
409 first electrical signal
410 second electrical signal

1. An optical receiver comprising:
a local light oscillation unit that generates a local oscillation light with a constant intensity;
a light mixing unit that mixes the local oscillation light and a first signal light and outputting the mixed light as a second signal light;
a light receiving unit that converts the second signal light into an electrical signal and outputting the electrical signal as a first electrical signal;
an amplifying unit that amplifies the first electrical signal with a predetermined gain and outputting the amplified signal as a second electrical signal; and
a signal processing circuit that processes the second electrical signal, wherein
the predetermined gain is set so that the amplitude of the second electrical signal may be within an allowable input amplitude range of the signal processing circuit.

2. The optical receiver described in claim 1, further comprising a first monitor unit that monitors the first signal light and outputting a signal corresponding to an electric power of the first signal light, wherein the predetermined gain is set based on the signal outputted by the first monitor unit.

3. The optical receiver described in claim 1, comprising a second monitor unit that monitors the second electrical signal and outputting a signal corresponding to an amplitude of the second electrical signal, wherein the predetermined gain is set based on the signal outputted by the second monitor unit.

4. The optical receiver described in claim 1, wherein the electric power of the local oscillation light is set based on a quantum efficiency that is a value obtained by dividing the electric power of the first electrical signal by the electric power of the second signal light.

5. The optical receiver described in claim 4, wherein the electric power of the local oscillation light is set so that a product of a square root of the electric power of the local oscillation light and the quantum efficiency is equal to a predetermined value.

6. The optical receiver described in claim 1, further comprising an ADC (analog-digital converter) that converts the second electrical signal into a digital signal and outputs the digital signal to the signal processing circuit.

7. The optical receiver described in claim 6, wherein the predetermined gain is set so that the amplitude of the second electrical signal inputted to the ADC is within an allowable input amplitude range of the ADC.

8. The optical receiver described in claim 1, further comprising a polarized wave separation unit that performs polarization separation of the received signal light to obtain a third signal light and a fourth signal light, wherein
the optical mixing unit separates each of the third signal light and the fourth signal light into an I (inphase) signal and a Q (quadrature) signal that are orthogonal to each other, and outputs the separated signals as the second signal light.

9. A method for controlling an optical receiver, comprising:
generating a local oscillation light with a constant intensity;
mixing the local oscillation light and a first signal light and outputting the mixed light as a second signal light;
converting the second signal light into an electrical signal and outputting the electrical signal as a first electrical signal; and
amplifying the first electrical signal with a predetermined gain and outputting the amplified signal as a second electrical signal, wherein
the predetermined gain is set so that the amplitude of the second electrical signal may be within a predetermined range.

10. An optical receiver comprising
local light oscillation means for generating a local oscillation light with a constant intensity,
light mixing means for mixing the local oscillation light and a first signal light and outputting the mixed light as a second signal light,
light receiving means for converting the second signal light into an electrical signal and outputting the electrical signal as a first electrical signal,
amplifying means for amplifying the first electrical signal with a predetermined gain and outputting the amplified signal as a second electrical signal, and
a signal processing circuit for processing the second electrical signal, wherein the gain is set so that the amplitude of the second electrical signal may be within an allowable input amplitude range of the signal processing circuit.
